(19) United States
(12) Patent Application Publication
(10) Pub. No.: US 2012/0273102 A1
(43) Pub. Date: Nov. 1, 2012

(54) TYRE HAVING MULTI-LEVEL AUDIBLE WEAR INDICATORS

(75) Inventor: Antoine Paturle, Pont du Chateau (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/516,939

(22) PCT Filed: Dec. 15, 2010
(86) PCT No.: PCT/FR2010/052741

§ 371 Date: Jul. 10, 2012

(30) Foreign Application Priority Data
Dec. 18, 2009 (FR) 0959245

(51) Int. Cl. B60C 11/24

(52) U.S. Cl. 152/154.2

(57) ABSTRACT

A tyre for a vehicle has at least two predetermined radial wear thresholds. Beyond each threshold, a tread of the tyre is configured in such a way that the tread includes at least one set of at least one cavity, known as a “sounding” cavity, associated with that threshold. If a set includes a plurality of cavities, each cavity of the set is substantially aligned axially with each other cavity of the set. A number of the set(s) of cavity/cavities associated with each threshold is different from a number of the set(s) of cavity/cavities associated with each other threshold. The sets of sounding cavities are arranged in such a way that, beyond each threshold, the set(s) of sounding cavity/cavities associated with that threshold are evenly circumferentially distributed about the tyre.

The invention relates to the field of vehicle tyres and detection of the level of wear thereof.

As a tyre drives along the ground, its tread, which is in contact with the ground, becomes worn through friction. This wear notably leads to a reduction in the depth of tread blocks formed in the tread.

For obvious safety reasons, it is important to check the tyre tread for wear before this wear becomes too great and too significantly impairs the performance of the tyre, notably on a snowy road surface or a wet road surface.

To make it easier to check for wear and detect excessive wear, tyres are commonly fitted with visual wear indicators that allow the user to differentiate between several levels of wear.

One example of a multi-level wear indicator commonly used employs three letters “DWS” (which stand for dry-wet-snow) formed within the tread of the tyre and the depth of which corresponds to the wear threshold beyond which the tyre will no longer perform as well or as reliably under the conditions corresponding to that letter. Thus, when all three letters “DWS” are visible, the depth of the tread blocks is enough for all the conditions of use. When the letter “S” disappears, the remaining letters “DW” indicate that the tread blocks are deep enough for most conditions of driving on a dry or wet road surface. Finally, when the letter “W” disappears, the remaining letter “D” indicates that the tread blocks are of a suitable depth for conditions of driving on a dry road surface.

One disadvantage of this type of wear indicator is that the driver of the motor vehicle has to remain vigilant and regularly visually check the condition of his tyres. However, many drivers omit to carry out such checks and change their tyres too late, for example when, during compulsory vehicle testing, a garage mechanic checks the wear condition of the tyres.

Further, this type of wear indicator is unable to alert the driver of the vehicle until one of the wear thresholds has been reached and this does not make it possible to anticipate the reaching of the threshold above. Thus, although they are attentive to the tyre wear of their vehicles, many drivers drive around in driving conditions with tyres that have reached one of the wear thresholds and are not able to perform correctly and reliably under the conditions corresponding to that threshold.

It is a particular object of the invention to provide a tyre having a more effective and reliable type of wear indicator.

To this end, the subject of the invention is a tyre for a vehicle comprising a tread and having at least two predetermined radial wear thresholds, characterized in that:
beyond each threshold, the tread is configured in such a way that it comprises at least one set of at least one cavity known as a “sounding” cavity associated with the threshold; each cavity of each set being substantially aligned axially with each other cavity of the set and the number of sets of sounding cavity/cavities associated with each threshold being different from the number of sets of sounding cavity/cavities associated with each other threshold, and
the sets of sounding cavity/cavities associated with each threshold are arranged in such a way that, beyond each threshold, the sets of sounding cavity/cavities associated with each threshold are evenly circumferentially distributed about the tyre.

“Evenly circumferentially distributed” means that each set of cavity/cavities associated with a given threshold is situated substantially the same spatial distance away from the two sets of cavity/cavities adjacent to it. If just one set is associated with a given threshold, this one set is also evenly circumferentially distributed. Specifically, in such an instance, the adjacent sets are formed by this same set.

The cavities associated with the various thresholds have a special shape which gives them sounding properties, which means that these cavities make a characteristic noise as the worn tyre is driven on.

For each cavity associated with each threshold, this characteristic noise does not appear until the tyre has been worn down beyond the corresponding threshold. Each cavity associated with a threshold thus forms an audible wear indicator once said threshold has been crossed.

Thus, even if the driver does not regularly visually inspect the surface condition of his tyres, he will be informed of the crossing of each threshold when, as he drives along, he hears a characteristic hissing sound.

For preference, use is made of a processing unit and of one or more microphones to detect road noise, these microphones being connected to the processing unit capable of discerning the hissing noise from the road noise and of informing the driver that his tyres are worn.

Because of the different number of sets of sounding cavities associated with each threshold, the characteristics of the noise emitted by the sounding cavities once each threshold has been crossed are different. Thus, for a given speed, beyond a given threshold, the noise emitted by all of the cavities associated with this given threshold has certain characteristics whereas beyond another threshold the noise emitted by all of the cavities associated with this other threshold has other characteristics. Thus it is possible, using the processing unit, to make a distinction between the reaching of each wear threshold.

Furthermore, in all instances, because the sets of cavity/cavities are evenly circumferentially distributed about the tyre tread irrespective of the threshold reached, the characteristics of the noise emitted beyond each threshold are unique and discernible. Thus, the noise emitted by the tyre is readily detectable from the road noise made by the tyre, the wind, the engine noise or the noise of the drive train associated therewith. Specifically, the noise emitted beyond each threshold has, in the frequency domain, the form of a characteristic Dirac comb that can be readily identified from among all the parasitic noise listed above.

The cavities may be axially offset from one another while at the same time being evenly circumferentially distributed about the tread.

It will be noted that in all the embodiments and alternative forms associated therewith, the characteristics of the cavities associated with each threshold ensure the even circumferential distribution of the cavities beyond each threshold irrespective of the number of cavities associated with each threshold and of their axial arrangement.

In one embodiment, each set consists of a single sounding cavity.

In another embodiment, each set comprises at least two cavities substantially aligned axially with one another.

In this embodiment, one cavity of a set associated with a threshold has substantially the same azimuth as that of another cavity of the set associated with the same threshold. Thus, these cavities sound simultaneously.

In another embodiment, two axially aligned cavities are associated with two different thresholds. In that case, the two cavities do not form part of the same set.

Optionally, beyond each threshold, each sounding cavity opens radially to the outside of the tyre and is configured in such a way as to be closed by the ground in a substantially airtight manner as it passes through the contact patch in which the tyre is in contact with the ground.

Specifically, because each cavity is configured in such a way so as to be closed by the ground in a substantially airtight manner, it temporarily traps air as it passes through the contact patch in which the tyre is in contact with the ground. Now, under the effect of the deformation of the tyre in the contact patch, this air trapped in the cavity is compressed and then suddenly expanded as it leaves the contact patch when the tread breaks contact with the ground at the rear of the tyre and the cavity therefore opens.

This expansion of the air lasts of the order of a few milliseconds and gives rise to a specific noise, sometimes known as hissing or tread pattern noise, which is notably dependent on the shape and volume of the cavity.

Given that this hissing phenomenon occurs only when air is compressed in the cavity and then expanded as it escapes from the cavity, it is important that this cavity be closed in a substantially airtight manner by the ground as it passes through the contact patch. Indeed a cavity the top of which would be covered by the ground but which elsewhere would have transverse channels in fluidic communication with the outside air would not form a sounding cavity because the air it contains would not be able to be compressed. Such is notably the case of the tread blocks of tyre treads of the prior art which are generally formed of a network of channels causing the various cavities to intercommunicate and to communicate with the outside air.

Likewise, a cavity the dimensions of which would be too great to be able to be completely covered by the ground as it passed through the contact patch, for example a cavity of a length greater than the length of the contact patch, would not be able to form a sounding cavity within the meaning of the invention.

Advantageously, the tyre comprises:
at least one circumferential groove of a depth that is predetermined when the tyre is new, and
at least two ribs formed transversely at the bottom of the groove, of a height that is predetermined when the tyre is new and that is substantially equal to the difference between the predetermined depth of the groove and one of the predetermined wear thresholds,

and the distance separating the two ribs is less than a distance that is predetermined so that, beyond one or each of the predetermined radial wear thresholds, the cavity formed by the groove and delimited by the two ribs sounds.

By placing the cavities in the grooves, the noise emitted by the cavities is amplified by comparison with audible wear indicators positioned elsewhere in the tread. The noise emitted is also amplified by a bell mouth formed by the tyre and the ground once each cavity has passed beyond the contact patch. This bell mouth effect amplification is at its maximum when each sounding cavity is preferably arranged axially in a central part of the contact patch of the tyre.

What is meant by a central part of the contact patch is that region of the contact patch that extends axially over approximately half the width of this contact patch under nominal load and pressure conditions and which is centred relative to the central mid-plane of the tyre.

In another embodiment, each sounding cavity comprises a pair of cells respectively arranged in first and second circumferential grooves of the tread and a channel joining the two cells of the pair together.

Advantageously, the tread is configured in such a way that, beyond each threshold and over a predetermined wear range associated with this threshold, the total volume of the sounding cavities associated with this threshold is greater than or equal to a non-zero predetermined minimum volume.

The volume of the cavity is the volume delimited by the walls of the cavity closed by the ground when the cavity comes into contact with the ground.

Such a predetermined volume of the cavities guarantees that, for each threshold, over the predetermined wear range, the intensity of the hissing sound is strong enough to be distinguished despite the road noise, the engine noise and the associated drive train noise. The wider the predetermined wear range, the longer the total volume of the cavities associated with each threshold will be higher than the predetermined minimum volume and therefore the longer the intensity of the hissing will be strong enough to be discerned from all the parasitic noise.

Further, the minimum value of the volume is preferably low enough that cavities can be made in a conventional tyre without appreciably impairing its performance.

For preference, two predetermined wear ranges associated with two consecutive thresholds have at least one wear value in common.

Thus, irrespective of the level of wear of the tyre, the total volume of the cavities is greater than the predetermined minimum volume. Specifically, for the wear value in common or the interval of values in common, the total volume of the cavities associated with each threshold is greater than the predetermined minimum volume. Wear can therefore be detected permanently. Because the number of cavities differs for each threshold, it is still possible to determine which wear threshold is reached despite the wear value in common or the interval of values in common thanks to the characteristics of the noise emitted by the sounding cavities which are specific to each threshold.

According to one optional characteristic, the range Pᵢ associated with each threshold Sᵢ is defined by Pᵢ=[Sᵢ; H−Vₘᵢₙ/(Nᵢ.S)] in which H is the depth between the bottom of the sounding cavity and the surface of the tyre in the new condition, Vₘᵢₙ is the predetermined minimum volume, Nᵢ is the number of sounding cavity/cavities associated with the threshold Sᵢ and S is the contact cross section of each sounding cavity associated with the threshold Sᵢ as it passes through the contact patch in which the tyre is in contact with the ground.

Advantageously, each threshold Sᵢ satisfies the following relationship: Sᵢ₊₁≧H−Vₘᵢₙ/(Nᵢ.S) with i>1 and/or Sᵢ≧H−Vₘᵢₙ/(Nᵢ.S) with i=1 in which H is the depth between the bottom of the sounding cavity and the surface of the tyre in the new condition, Vₘᵢₙ is the predetermined minimum volume, Nᵢ is the number of sounding cavity/cavities associated with the threshold Sᵢ and S is the contact cross section of each sounding cavity associated with the threshold Sᵢ as it passes through the contact patch in which the tyre is in contact with the ground.

This characteristic regarding each threshold Sᵢ makes it possible to ensure that the cavities associated with one threshold appear before the wear range associated with the threshold below has been exceeded. Thus, it is guaranteed that the total volume of the cavities associated with each threshold Sᵢ is greater than the predetermined minimum volume.

Optionally, the height hᵢ, that is predetermined when the tyre is new, of each rib delimiting a cavity associated with the threshold Sᵢ satisfies the following relationship: hᵢ₊₁≧Vₘᵢₙ/(Nᵢ.S) with i>1 and/or hᵢ≧Vₘᵢₙ/(Nᵢ.S) with i=1 in which Vₘᵢₙ is the predetermined minimum volume, Nᵢ is the number of sounding cavity/cavities associated with the threshold Sᵢ and S is the contact cross section of each sounding cavity associated with the threshold Sᵢ as it passes through the contact patch in which the tyre is in contact with the ground.

This characteristic regarding each height hᵢ is analogous to the characteristic regarding each threshold Sᵢ. Thus, it is guaranteed that the total volume of the cavities associated with each threshold Sᵢ is greater than the predetermined minimum volume.

Advantageously, the predetermined minimum volume is substantially equal to 2 cm³ and preferably 4 cm³.

In one embodiment said to have a “descending” sounding pattern, the numbers NEᵢ, NEᵢ₊₁ of sets of sounding cavity/cavities associated respectively with two consecutive thresholds Sᵢ, Sᵢ₊₁ satisfy NEᵢ<NEᵢ₊₁, the threshold Sᵢ₊₁ being higher than the threshold Sᵢ.

In other words, the number NEᵢ of sets of sounding cavities increases with the wear of the tyre.

In this embodiment, by increasing the number of sets and therefore the number of cavities, the total volume of the cavities can increase at each threshold. It is found that the detection of the noise emitted by the cavities is then easier as the tyre gradually wears.

In an alternative form of this embodiment, each cavity associated with a given threshold is also associated with the threshold above the given threshold. This makes it possible to minimize the number of cavities that appear at each threshold. Thus, the effect that the cavities have on tyre performance, notably on hydrodynamic performance, is minimized. Thus, each cavity associated with a given threshold is also associated with all the thresholds above the given threshold. This feature obviously does not apply to the cavities of the uppermost threshold.

In another alternative form of this embodiment, the sounding cavity or cavities associated with a given threshold have no sounding cavity associated with the threshold below the given threshold. Thus, when the given threshold is reached, the cavity or cavities associated with the threshold below the given threshold stop sounding. In other words, each set of cavities is strictly associated with just one wear threshold.

In another alternative form, the sounding cavity or cavities associated with a given threshold comprise a proportion of the sounding cavities which are associated with the threshold below the given threshold and the sounding cavities which appeared beyond the given threshold. Thus, only a few sounding cavities associated with the threshold below are also sounding cavities associated with the given threshold.

Advantageously, kᵢ=NEᵢ₊₁/NE_{T}>1 for any value of iε[1, M] where M is the total number of predetermined radial wear thresholds and kᵢ is a natural integer.

In another embodiment said to have an “ascending” sounding pattern, the numbers NEᵢ, NEᵢ₊₁ of sets of sounding cavity/cavities associated respectively with two consecutive thresholds Sᵢ, Sᵢ₊₁ satisfy NEᵢ>NEᵢ₊₁, the threshold Sᵢ₊₁ being higher than the threshold Sᵢ.

In other words, the number NEᵢ of sets of sounding cavities decreases with the wear of the tyre.

The sounding cavities, when arranged in the grooves, may impair the performance of the tyre by comparison with a tyre that does not have such sounding cavities, notably in terms of the ability of the grooves to discharge water. This impairment of water discharge performance becomes all the greater the more pronounced the tyre wear. Thus, by reducing the number of sets of sounding cavities and therefore the number of sounding cavities with more pronounced tyre wear, the potential loss of performance caused by the sounding cavities is limited. The counterpart of this is that it is preferable to have enough cavities that the total volume of the cavities is sufficiently great, notably that it exceeds the predetermined minimum volume.

In an alternative form of this embodiment, the sounding cavity or cavities associated with a given threshold no longer sound or disappear beyond the threshold above the given threshold. The sounding cavities associated with the threshold above the given threshold are therefore only cavities that appear beyond the threshold above the given threshold. In other words, each cavity is strictly associated with just one wear threshold.

In another alternative form of this embodiment, the sounding cavity or cavities associated with a given threshold comprise some of the sounding cavity or cavities associated with a threshold below the given threshold.

Advantageously, kᵢ=NEᵢ/NEᵢ₊₁>1 for any value of iε[1, M] where M is the total number of predetermined radial wear thresholds and kᵢ is a natural integer.

In one embodiment, the tread is configured in such a way that at least one of the sounding cavities has, as it passes through the contact patch in which the tyre is in contact with the ground, a contact cross section that varies as a function of the wear of the tyre.

Thus, the volume of a sounding cavity can be varied in ways other than by altering its height. This then gives an additional parameter for satisfying the condition of even distribution and the optional volume condition. This parameter thus gives greater freedom of choice as to the number of cavities associated with each threshold.

For preference, the contact cross section increases with the wear of the tyre.

The loss of volume associated with the reduction in the height of the cavity can be compensated for by increasing the surface area of the contact cross section with wear.

In another embodiment, the tread is configured in such a way that at least one of the sounding cavities has, as it passes through the contact patch in which the tyre is in contact with the ground, a contact cross section that is constant as a function of the wear of the tyre.

Advantageously, the tread is configured in such a way that at least one of the sounding cavities has, as it passes through the contact patch in which the tyre is in contact with the ground, a contact cross section that varies as a function of the wear of the tyre.

Optionally, the tread is configured in such a way that, beyond each radial wear threshold, all the sounding cavities are identical.

The invention will be better understood from reading the description which follows, given solely by way of nonlimiting example and made with reference to the drawings in which:

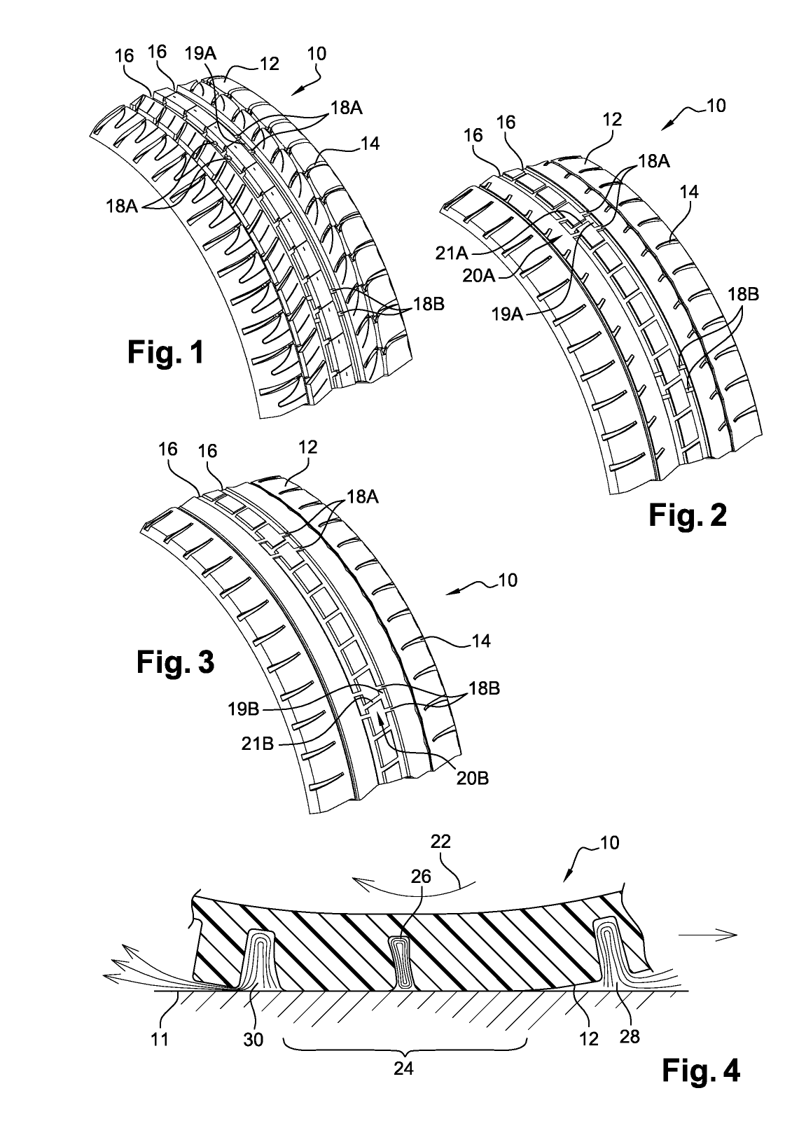

FIG. 1 is a diagram of the tread of a new tyre with a “descending” sounding pattern according to a first embodiment;

FIGS. 2 and 3 are diagrams of the tread of the tyre depicted in FIG. 1, which has been worn respectively beyond first and second wear thresholds;

FIG. 4 is a diagram in radial cross section of the tread of the tyre depicted in FIG. 3;

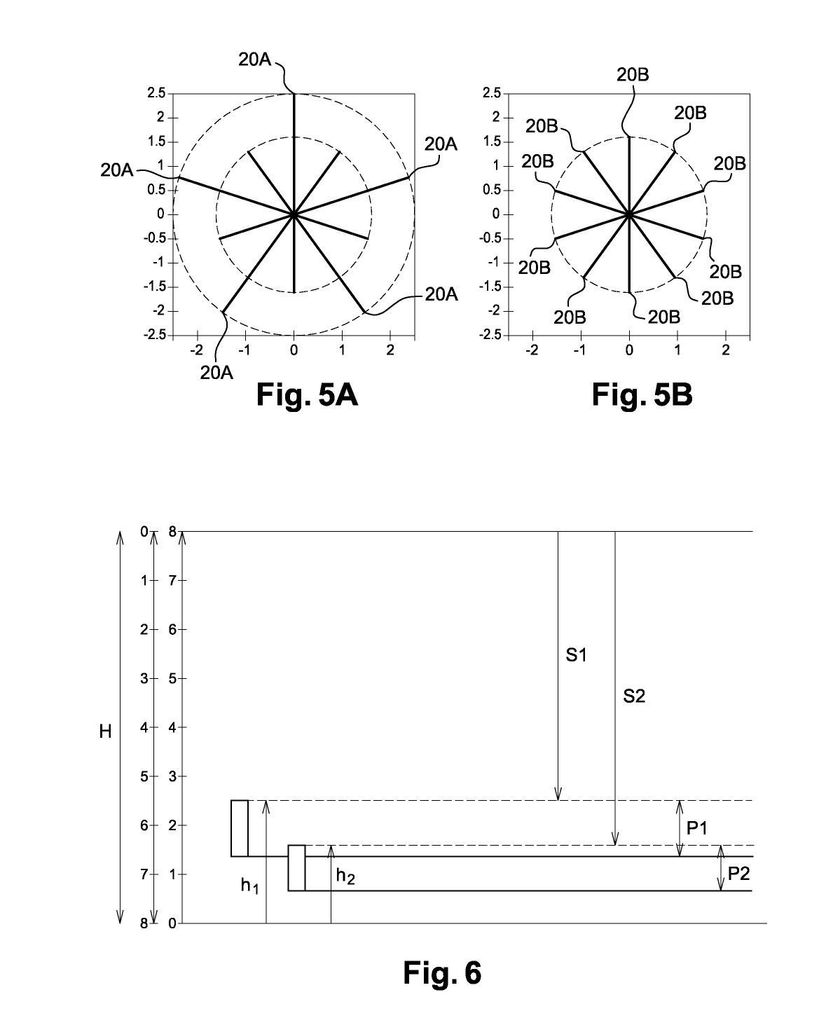

FIGS. 5A and 5B schematically illustrate the distribution of the sets of sounding cavities of the tyre of FIGS. 1 to 3;

FIG. 6 schematically illustrates the various characteristics satisfied by the cavities and the various wear thresholds of the tyre according to the first embodiment;

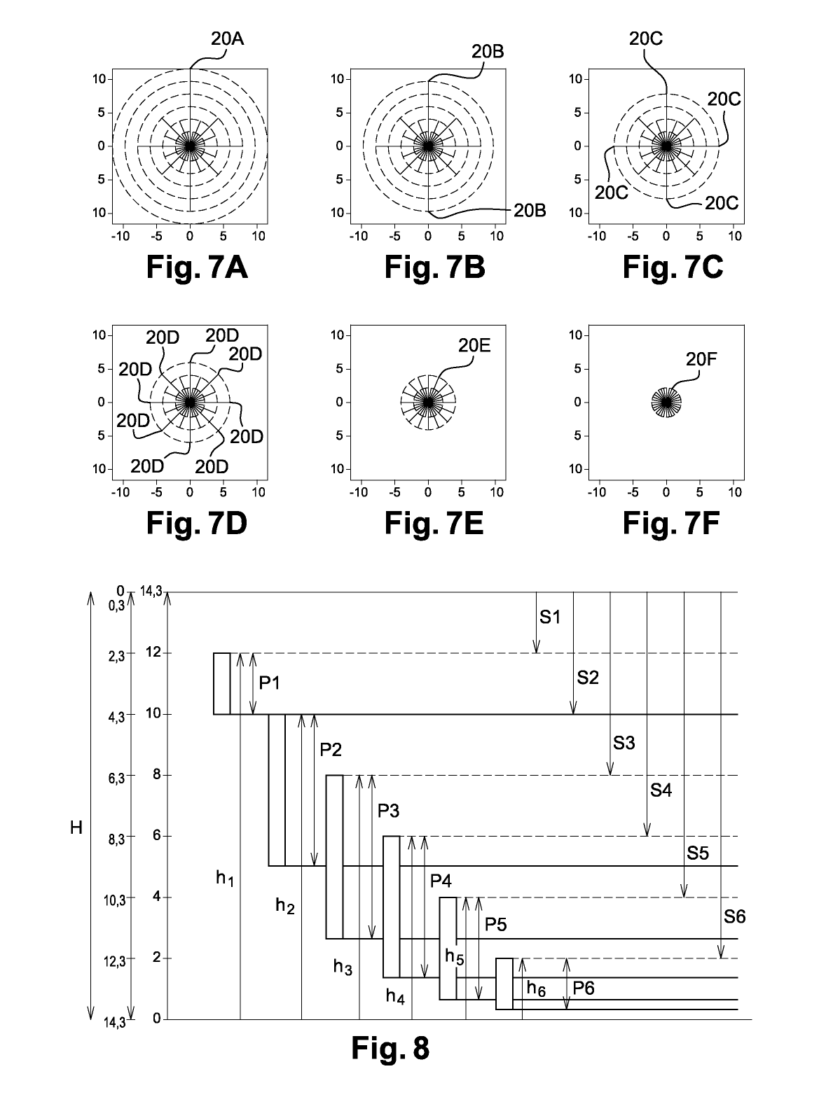

FIGS. 7A to 7F schematically illustrate the distribution of the sets of sounding cavities of a tyre with a “descending” sounding pattern according to a second embodiment;

FIG. 8 schematically illustrates the various characteristics satisfied by the cavities and the various wear thresholds of the tyre of FIGS. 7A-7F according to the second embodiment;

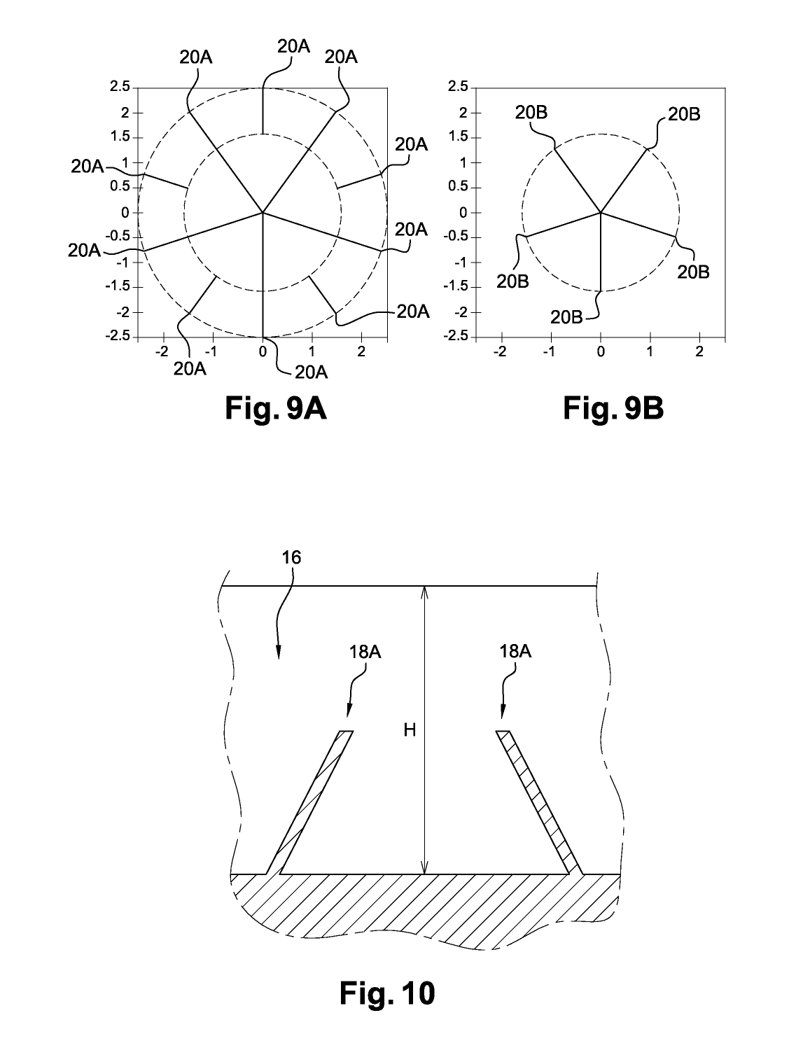

FIGS. 9A and 9B schematically illustrate the distribution of the sets of sounding cavities of a tyre with an “ascending” sounding pattern according to a third embodiment; and

FIG. 10 illustrates a cavity of a tyre according to a fourth embodiment.

FIG. 1 depicts part of a tyre according to a first embodiment of the invention, denoted by the general reference 10. The tyre 10 is intended for a passenger car. The tyre 10 is substantially axisymmetric about an axis.

The tyre 10 comprises a tread 12 of substantially cylindrical shape, the external surface of which is provided with tread blocks 14. In particular, the tread 12 comprises two circumferential and parallel grooves 16 cut into the surface of the tyre, of a depth H that is predetermined when the tyre 10 is new. The depth H of these grooves 16 is of the order of 8 mm and their width is of the order of 10 mm.

The tyre 10 comprises visual wear indicators (not illustrated) indicating a threshold SL which is the legal tread depth requirement of the tyre. The depth of each groove corresponding to the threshold SL is set at 1.6 mm, which corresponds to a threshold SL=6.4 mm.

Running transversely to the grooves 16, the tread 12 of the tyre comprises a set of ribs 18 formed at the bottom of the grooves 16. The set of ribs comprises two types of ribs 18A, 18B each corresponding to at least one predetermined tyre wear threshold S₁, S₂. Each rib 18A, 18B respectively has a first and second height h₁, h₂, that is predetermined when the tyre is new. h₁>h₂ and S₂>S₁ such that each rib of type 18A is associated with the thresholds S₁ and S₂ and each rib of type 18B is associated only with the threshold S₂. The first threshold S₁ corresponds substantially to 90% of the threshold SL, which means to say that h₁=2.5 mm and S₁=5.5 mm. The second threshold S₂ corresponds substantially to 100% of the threshold SL, which means to say that h₂=1.6 mm and S₂=6.4 mm. The thresholds S₁, S₂ are schematically depicted in FIGS. 5A-5B. FIG. 5A depicts the tyre 10 which has reached the first wear threshold S₁ but has not yet reached the second wear threshold S₂. FIG. 5B depicts the tyre 10 when it has reached the second wear threshold S₂.

Thus, in this embodiment, the first threshold S₁ corresponds to wear beyond which the tyre exhibits performance that may be impaired on a wet road surface. The second threshold S₂ itself corresponds to wear beyond which the tyre no longer meets the legal requirements.

The distance separating two ribs of the same type is of the order of 20 to 30 millimetres. The volume defined by a groove 16 and two adjacent ribs 18A, 18B respectively forms a cell 19A, 19B arranged in each circumferential groove 16. Each cell 19A, 19B of each pair of cells 19A, 19B is connected to the other cell of the pair by a transverse channel 21A, 21B. Each pair of cells 19A and the channel 21A form a set made up of a cavity 20A opening radially to the outside of the tyre 10. Likewise, each pair of cells 19B and the channel 21B form a set made up of a cavity 20B opening radially to the outside of the tyre 10. FIGS. 5A-5B schematically depict the cavities 20A, 20B using dashes. These dashes run radially over a radial portion, schematically indicating between which thresholds the corresponding cavities sound.

When the tyre is new, as has been depicted in FIG. 1, the height of the ribs 18A, 18B is smaller than the depth of the grooves 16 so that each cavity 20A, 20B comprises a fluidic-communication passage situated above the ribs 18A, 18B, that is to say at the top of the ribs 18A, 18B. Thus, even when the tread is in contact with flat and smooth ground 11, the ground 11 does not completely close off the cavities 20A, 20B because the top of the ribs is not in contact with the ground 11. This being so, the various cavities 20A, 20B are in fluidic communication via a throttling channel delimited by the top of the ribs and the ground 11 covering the cavities.

FIG. 2 depicts the tyre 10 of FIG. 1 which has been worn beyond the threshold S₁. In other words, this is a tyre which has covered a great many kilometres and the tread 12 of which has been progressively worn down until it has lost a few millimetres. This tyre 10 is also depicted schematically in FIG. 5A where it can be seen that, beyond the threshold S₁, the tyre 10 comprises NE₁=5 sets each consisting of one cavity 20A. Therefore NE₁=N₁=5. As the tyre rotates, the cavities 20A are, from the viewpoint of the tyre driving along, evenly circumferentially distributed on the tread 12 so that each cavity 20A periodically comes into contact with the ground as the tyre drives along at substantially constant speed.

In this particular instance, the wear of the tread 12 of the tyre 10, which wear is depicted in FIG. 2, is 6 mm, which means greater than the threshold S₁, or in other words greater than the distance which, when the tyre 10 is new, separates the top of the ribs 18A from the surface of the tread 12. Given that the wear is greater than S₁, the top of the ribs 18A is at the same level as the surface of the tread 12. Thus, the mouth of each cavity 20A is defined by a substantially planar contour formed on the tread 12 and the cavities 20A are distinct and separated from the other cavities.

The tyre wear is below the threshold S₂, or in other words less than the distance which, when the tyre 10 is new, separates the top of the ribs 18B from the surface of the tread 12. The top of the ribs 18B is at a lower level than that of the tread at this stage of wear.

Beyond the threshold S₁, each cavity 20A has a depth smaller than the height h₁. Here, the depth is less than 2.5 mm and is 2 mm for 6 mm of wear. The height of each rib 18A is therefore equal to the depth of each cavity 18A. This height or depth is equal to the difference between the depth of each groove 16 and the amount of wear of the tyre 10.

Because the mouth of each cavity 20A is defined by a substantially planar contour, it can be perfectly and hermetically sealed off by smooth and flat ground during driving. In other words, when the tyre 10 is worn beyond the threshold S₁, each cavity 20A is configured so as to be closed by the ground in a substantially airtight manner as it passes through the contact patch in which the tyre 10 is in contact with the ground. Between the thresholds S₁ and S₂, each cavity 20B is not closed by the ground in an airtight manner because of the throttling channel delimited by the top of each rib 18B and the ground 11.

FIG. 3 depicts the tyre 10 of FIGS. 1 and 2 which has become worn beyond the threshold S₂. This tyre 10 is also depicted schematically in FIG. 5B which shows that, beyond the threshold S₂, the tyre 10 comprises NE₂=10 sets each consisting of one cavity 20B. Therefore NE₂=N₂=10.

In this particular instance, the wear of the tread 12 of the tyre 10, which wear is depicted in FIG. 3, is 7 mm, which means to say greater than the threshold S₂, but also than the threshold S₁, or in other words greater than the distance which, when the tyre 10 is new, separates the top of the ribs 18B from the surface of the tread 12. Given that the wear is greater than S₂, the top of the ribs 18B, and also the top of the ribs 18A, is at the same level as the surface of the tread 12. Thus, the mouth of each cavity 20B is defined by a substantially planar contour formed on the tread 12 and the cavities 20B are distinct and separated from the other cavities. The mouth of each cavity 20A remains unchanged by comparison with the mouth obtained beyond the threshold S₁ and before the threshold S₂ is reached.

Beyond the threshold S₂, each cavity 20B has a depth less than the height h₂. Here, the depth is less than 1.6 mm and measures 1 mm for 7 mm of wear. The height of each rib 18A, 18B is therefore equal to the depth of each cavity 18A, 18B. This height or depth is equal to the difference between the depth of each groove 16 and the amount of wear of the tyre 10.

Because the mouth of each cavity 20A, 20B is defined by a substantially planar contour, it can be perfectly and hermetically sealed off by smooth and flat ground during driving. In other words, when the tyre 10 is worn beyond the threshold S₂, each cavity 20A, 20B is configured so as to be closed by the ground in a substantially airtight manner as it passes through the contact patch in which the tyre 10 is in contact with the ground.

Beyond the corresponding threshold S₁, S₂, each cavity 20A, 20B has a length of the order of 20 to 30 millimetres corresponding to the circumferential separation between two adjacent ribs 18A, 18B of one and the same cavity.

Such cavities 20A, 20B formed at the surface of the tread 12 of a tyre which, on the one hand, open radially to the outside of the tyre and, on the other hand, are configured to be hermetically closed as they pass through the contact patch are said to be “sounding” cavities. In this embodiment, each cavity 20A sounds beyond each threshold S₁, S₂ whereas each cavity 20B sounds only beyond the threshold S₂. In the example illustrated, the numbers NEᵢ, NEᵢ₊₁ of sets of cavities associated respectively with two consecutive thresholds Sᵢ, Sᵢ₊₁ satisfy NEᵢ<NEᵢ₊₁, the threshold Sᵢ₊₁ being above the threshold Sᵢ. A tyre in which NE₂>NE₁ is thus qualified as being a tyre with a “descending” sounding pattern. In this embodiment, k₁=NE₂/NE₁=N₂/N₁=2.

The cavities 20A, 20B are arranged so that, beyond each threshold S₁, S₂, the sets of sounding cavities 20A, 20B are evenly circumferentially distributed about the tyre 10. As each set consists of a single cavity, the sounding cavities 20A, 20B are therefore evenly circumferentially distributed about the tyre 10. Further, the tread is configured in such a way that, beyond each threshold S₁, S₂, all the sounding cavities 20A, 20B are identical as has been illustrated in FIGS. 5A-5B.

Further, each cavity 20A associated with the threshold S₁ is also associated with the threshold S₂. In the tyre 10, such sounding cavities do not exist until the threshold S₁ is reached, and notably do not exist when the tyre is new.

The tread 12 is configured in such a way that, beyond each threshold S₁, S₂ and over a predetermined wear range P₁, P₂ associated respectively with each threshold S₁, S₂, the total volume of the sounding cavities 20A, 20B associated respectively with each threshold S₁, S₂ is greater than or equal to a predetermined minimum volume Vₘᵢₙ. Each range P₁, P₂ is a function of parameters of the tyre 10, notably of the thresholds S₁, S₂, the depth between the bottom of each sounding cavity and the surface of the tyre in the new condition, in this instance the depth H of the groove 16, the predetermined minimum volume Vₘᵢₙ, the number Nᵢ of sounding cavities associated with each threshold S₁, S₂ and the contact cross section S of each sounding cavity associated with each threshold S₁, S₂ as it passes through the contact patch 24 in which the tyre 10 is in contact with the ground 11. In this particular instance, Vₘᵢₙ=4000 mm³ and S=600 mm².

As depicted in FIG. 6, the range P₁ associated with the threshold S₁ is defined by P₁=[S₁; H−Vₘᵢₙ/(N₁.S)]=[5.5; 6.6] and the range P₂ associated with the threshold S₂ is defined by P₂=[S₂; H−Vₘᵢₙ/(N₂.S)]=[6.4; 7.3]. The two ranges P₁, P₂ associated with the consecutive thresholds S₁, S₂ have at least one wear value in common, in this instance the values in the interval [6.4-6.6].

Thus, the total volume of the cavities 20A associated with the threshold S₁ varies from 7500 mm³ to 4200 mm³ in the range P₁ and is therefore greater than or equal to the volume Vₘᵢₙ in the range P₁. Likewise, the total volume of the cavities 20B associated with the threshold S₂ varies from 9600 mm³ to 4200 mm³ in the range P₂ and is therefore greater than or equal to the volume Vₘᵢₙ throughout the range P₂.

Further, the threshold S₁ satisfies the following relationship: S₁≦H−Vₘᵢₙ/(Nᵢ.S). Specifically, S₁=5.5≦6.6. When the tyre is new, the predetermined height h₁ of each rib delimiting a cavity 20A associated with the threshold S₁ satisfies the following relationship: h₁≧Vₘᵢₙ/(N₁.S). Specifically, h₂=2.5≧1.33. The threshold S₂ satisfies the following relationship: S₂≦H−Vₘᵢₙ/(N₁.S). Specifically, S₂=6.4≦6.6. When the tyre is new, the predetermined height h₂ of each rib delimiting a cavity 20B associated with the threshold S₂ satisfies the following relationship: h₂≧Vₘᵢₙ/(Nᵢ.S). Specifically, h₂=1.6≦1.33.

Thus, the threshold S₂ is reached before the total volume of the cavities associated with the threshold S₁ drops below Vₘᵢₙ. In this particular instance, when the first threshold S₁ is reached, the total volume of the N₁=5 cavities associated with the first threshold S₁ is equal to 7500 mm³. With wear, the height of the ribs 18A decreases leading to a reduction in volume of the cavities 20A. Before the total volume of the cavities 18A associated with the threshold S₁ drops below Vₘᵢₙ, the second threshold S₂ is reached. On the reaching of the second threshold S₂, the volume of the N₂=10 cavities associated with the second threshold S₂ is equal to 9600 mm³.

FIG. 4 depicts a view in radial cross section of a tyre similar to that of FIGS. 1 to 3 driving along the ground. The dimensions have been modified arbitrarily to make the description clearer. This tyre 10 is in a state of wear beyond the threshold S₂ and therefore comprises a set of sounding cavities 20A, 20B.

An arrow 22 has been used to depict the direction of rotation of the tyre 10 as it drives along the ground. At a given moment, part of the tread 12 of the tyre 10 is in contact with the ground. This part that is in contact is known as the contact patch 24. The tread 12 is configured in such a way that each sounding cavity 20A, 20B, as it passes through the contact patch 24 in which the tyre 10 is in contact with the ground 11, has a contact cross section that is constant as a function of the wear of the tyre 10.

In the example depicted in FIG. 4, the contact patch 24 comprises a sounding cavity 26 the radially exterior mouth of which is covered by the ground 11. Thus, this sounding cavity 26 is hermetically closed.

The contact patch 24 of the tyre also comprises a sounding cavity 28 situated upstream of the closed cavity 26 and which is open because its mouth is not in the contact patch and is therefore not covered by the ground. As the tyre is driven in the direction denoted by the arrow 22, the open cavity 28 will progress towards the contact patch 24 until its mouth is closed off by the ground 11.

Finally, the tread 12 of the tyre 10 also comprises a cavity 30 situated downstream of the closed cavity 26 with respect to the direction in which the tyre 10 rotates. In the example depicted in FIG. 4, the downstream cavity 30 depicted is open because the ground 11 is not in contact with the mouth thereof. At an earlier moment in time, this cavity 30 was closed because it was located in the region of the contact patch 24 in which the tyre is in contact with the ground 11.

Thus, as the tyre is driven on, a given sounding cavity successively occupies an upstream position 28 in which it is open, followed by a position 26 located in the contact patch 24 in which it is closed, because it is covered by the ground, and then finally an open position 30 once again in which it is no longer covered by the ground.

Stated differently, the rotation of the tyre causes, for a given cavity, air to be admitted into the cavity, the air contained in the cavity to be compressed when this cavity is closed by the ground in the contact patch 24, then the air contained in the cavity to expand as this cavity opens when the tread leaves contact with the ground.

This succession of admission/compression/expansion steps is what causes a characteristic noise, sometimes known as hissing or tread pattern noise resulting from the expansion of the compressed air contained in the cavity. The amplitude and frequency signature of this noise are notably dependent on the shape, the volume and the number of sounding cavities used. For preference, the cavities are configured in such a way that this noise can be detected by a user of the motor vehicle or by an electronic device.

FIGS. 7A-7F and 8 depict a tyre according to a second embodiment. The tyre 10 is intended for a vehicle of the heavy goods vehicle type. Elements analogous to those denoted in the previous figures are denoted by identical references.

In contrast with the first embodiment, the tyre 10 according to the second embodiment comprises six predetermined radial wear thresholds S₁-S₆ with NE₁=N₁=1, NE₂=N₂=2, NE₃=N₃=4, NE₄=N₄=8, NE₅=N₅=16, and NE₆=N₆=32 and therefore the following kᵢ ratios: k₁=k₂=k₃=k₄=k₅=k₆=NE₂/NE₁=N₂/N₁=NE₃/NE₂=N₃/N₂=NE₄/NE₃=N₄/N₃=NE₅/NE₄=N₅/N₄=NE₆/NE₅=N₆/N₅=2. As in the first embodiment, the tyre 10 has a “descending” sounding pattern.

The depth of the grooves 16 is of the order of 14 millimetres, in this instance 14.3 mm. The depth of each groove corresponding to the threshold SL is set at 2 mm, which corresponds to a threshold SL=12.3 mm.

The set of ribs comprises third, fourth, fifth and sixth types of ribs 18C-18F in addition to the ribs 18A, 18B. Each rib 18C-18F has a respective third, fourth, fifth, and sixth height h₃, h₄, h₅ and h₆ which is predetermined when the tyre is new. h₁>h₂>h₃>h₄>h₅>h₆ and S₆>S₅>S₄>S₃>S₂>S₁ so that each rib of type 18A is associated with the thresholds S₁-S₆, each rib of type 18B is associated with the thresholds S₂-S₆, each rib of type 18C is associated with the thresholds S₃-S₆, each rib 18D is associated with the thresholds S₄-S₆, each rib 18E is associated with the thresholds S₅ and S₆ and each rib 18F is associated only with the threshold S₆. The first threshold S₁ corresponds substantially to 19% of the threshold SL, namely h₁=12 mm and S₁=2.3 mm. The second threshold S₂ corresponds substantially to 35% of the threshold SL, namely h₂=10 mm and S₂=4.3 mm. The third threshold S₃ corresponds substantially to 51% of the threshold SL, namely h₃=8 mm and S₃=6.3 mm. The fourth threshold S₄ corresponds substantially to 67% of the threshold SL, namely h₄=6 mm and S₄=8.3 mm. The fifth threshold S₅ corresponds substantially to 84% of the threshold SL, namely h₅=4 mm and S₅=10.3 mm. The sixth threshold S₆ corresponds substantially to 100% of the threshold SL, namely h₆=2 mm and S₆=12.3 mm.

The various thresholds correspond to various stages in the life of the tyre during which stages various actions have to be undertaken in order to distribute the wear across the entire tread and thus increase the life of the tyre. Thus, the threshold S₂ corresponds to a level of wear for which the tyre can be swapped on one and the same axle. The threshold S₄ corresponds to a level of wear for which the tyre can be turned around. The threshold S₅ corresponds to a level of wear for which the tyre can be recut in order to restore its performance, notably its water discharge performance.

Just as in the first embodiment, the sets of cavities 20A-20F, in this instance the sounding cavities 20A-20F, are arranged in such a way that, beyond each threshold S₁-S₆, the sets of sounding cavities 20A-20F, in this instance the sounding cavities 20A-20F, are evenly circumferentially distributed about the tyre 10.

Further, each cavity 20A associated with the threshold S₁ is also associated with the threshold S₂-S₆, each cavity 20B is associated with the thresholds S₂-S₆, each cavity 20C is associated with the thresholds S₃-S₆, each cavity 20D is associated with the thresholds S₄-S₆, each cavity 20E is associated with the thresholds S₅ and S₆ and each cavity 20F is associated only with the threshold S₆.

In this embodiment, Vₘᵢₙ=2000 mm³ and S=200 mm². As depicted in FIG. 8, the ranges P₁-P₆ respectively associated with the thresholds S₁-S₆ are defined by P₁=[S₁; H−Vₘᵢₙ/ (Nᵢ.S)]=[2.3; 4.3], P₂=[S₂; H−Vₘᵢₙ/(N₂.S)]=[4.3; 9.3], P₃⁼[S₃; H−Vₘᵢₙ/(N₃.S)]=[6.3; 11.8], P₄=[S₄; H−Vₘᵢₙ/(N₄.S)]=[8.3; 13], P₅=[S₅; H−Vₘᵢₙ/(N₅.S)]=[10.3; 13.6] and P₆=[S₆; H−Vₘᵢₙ/(N₆.S)=12.3; 13.9]. The ranges P₁-P₆ associated with two consecutive thresholds S₁-S₆ have at least one wear value in common, in this instance the value 4.3 for the ranges P₁, P₂, the interval [6.3-9.3] for the ranges P₂, P₃, the interval [8.3; 11.8] for the ranges P₃, P₄, the interval [10.3; 13] for the ranges P₄, P₅ and the interval [12.3, 13.6] for the ranges P₅, P₆.

Thus, the total volume of the cavities 20A-20F respectively associated with the thresholds S₁-S₆ is greater than or equal to the volume Vₘᵢₙ in each range P₁-P₆. In this particular instance, the total volume of the cavities 20A-20F respectively associated with the thresholds S₁-S₆ varies from 2400 mm³ to 2000 mm³ in the range P₁, from 4000 mm³ to 2000 mm³ in the range P₂, from 6400 mm³ to 2000 mm³ in the range P₃, from 9600 mm³ to 2080 mm³ in the range P₄, from 12 800 mm³ to 2240 mm³ in the range P₅, and from 12 800 mm³ to 2560 mm³ in the range P₆. The total volume of the cavities is therefore greater than or equal to the volume Vₘᵢₙ in each range P₁-P₆.

Further, each threshold S₁-S₆ satisfies the following relationship: Sᵢ₊₁H≦Vₘᵢₙ/(Nᵢ.S) for i=2 to 6 and Sᵢ≦H−Vₘᵢₙ/(Nᵢ.S) for i=1. Specifically, S₁=2.3≦4.3, S₂=4.3≦4.3, S₃=6.3≦9.3, S₄=8.3≦11.8, S₅=10.3≦13 and S₆=12.3≦13.6. When the tyre is new, the predetermined height hᵢ of each rib delimiting a cavity associated with the threshold Sᵢ satisfies the following relationship: hᵢ₊₁Vₘᵢₙ/(Nᵢ.S) for i=2 to 6 and hᵢ≧Vₘᵢₙ/(Nᵢ.S) for i=1. Specifically, h₁=12≧10, h₂=10≧10, h₃=8≧5, h₄=6≧2.5, h₅=4≧1.25 and h₆=2≧0.625.

Thus, each threshold S₂-S₆ is reached before the total volume of the cavities associated respectively with the thresholds S₁-S₅ drops below Vₘᵢₙ.

FIGS. 9A-9B depict a third embodiment of a tyre according to the invention comprising two wear thresholds. Elements analogous to those denoted in the previous figures are denoted by identical references.

In contrast to the previous embodiments, the number of sets of sounding cavities 20A, 20B decreases with the wear of the tyre 10. The numbers NEᵢ, NEᵢ₊₁ of sets of cavities associated respectively with two consecutive thresholds Sᵢ, Sᵢ₊₁ satisfy NEᵢ>NEᵢ₊₁, the threshold Sᵢ₊₁ being above the threshold Sᵢ. In this particular instance, NE₂<NE₁. Such a tyre is qualified as a tyre with an “ascending” sounding pattern.

In contrast to the first embodiment, each sounding cavity 20B associated with the second threshold S₂ is also associated with the first threshold S₁. Just some of the sounding cavities 20A associated with the first threshold S₁ are also associated with the second threshold S₂.

FIG. 10 depicts a cavity 20 of a tyre according to a fourth embodiment. Elements analogous to those denoted in the preceding figures are denoted by identical references.

This FIG. 10 depicts a view in axial cross section of a groove 16.

In contrast with the other embodiments, the tread 12 is configured in such a way that the contact cross section of each cavity 20 that makes contact with the ground 11 can vary as a function of the wear of the tyre 10. In this instance, the contact cross section increases with wear so that the contact cross section beyond a given threshold is greater than the contact cross section beyond the threshold below the given threshold.

In FIG. 10, the ribs 18 are straight. As an alternative, they are curved.

Other variations in the contact cross section are possible. Thus, the contact cross section could decrease with wear.

The invention is not restricted to the embodiments described above.

Further, the tread could comprise more than two grooves and therefore sets of cavities comprising more than two cavities substantially aligned axially, that is to say having the same azimuth.

The tread could also comprise a single groove. Each cavity would then be formed by a cell.

The tread could comprise several grooves and each cavity comprise a single sounding cell such that two circumferentially successive cavities are situated in two different grooves.

The tread could comprise cavities arranged in each groove, the cavities being substantially aligned axially two by two without thereby being connected to one another by a channel. Such cavities could be associated with the same wear threshold or alternatively with two different wear thresholds.

In any event, the cavities may have a contact cross section that is variable or constant and may indifferently be used with tyres with “ascending” or “descending” sounding patterns.

By way of additional examples of a tyre with a descending sounding pattern, use could be made of tyres having three or four thresholds displaying the following characteristics:
NE₁=1, NE₂=2, NE₃=4, NE₄=8.
NE₁=1, NE₂=3, NE₃=6.
NE₁=1, NE₂=2, NE₃=6.
NE₁=2, NE₂=4, NE₃=8.
NE₁=2, NE₂=6, NE₃=12.
NE₁=3, NE₂=6, NE₃=12.

By way of additional examples of a tyre with an ascending sounding pattern, use could be made of tyres having three or four thresholds exhibiting the following characteristics:
NE₁=8, NE₂=4, NE₃=2, NE₄=1.
NE₁=9, NE₂=3, NE₃=1.
NE₁=12, NE₂=6, NE₃=2.

Further, it is possible, independently of the other characteristics of the tyre, to use a tyre for a vehicle having at least two predetermined radial wear thresholds, characterized in that:
beyond each threshold, the tread is configured in such a way that it comprises at least one set of at least one cavity known as a “sounding” cavity associated with the threshold; each cavity of each set being substantially aligned axially with each other cavity of the set and the number of sets of cavity/cavities associated with each threshold being different from the number of sets of cavity/cavities associated with the other thresholds, and
the tread is configured in such a way that, beyond each threshold and over a predetermined wear range associated with this threshold, the total volume of the sounding cavities associated with this threshold is greater than or equal to a predetermined minimum volume.

1-21. (canceled)

22. A tyre for a vehicle, the tyre comprising a tread having at least two predetermined radial wear thresholds,
wherein, beyond each threshold, the tread is structured in such a way that the tread includes at least one set of at least one sonic cavity associated with that threshold,
wherein, if a set includes a plurality of sounding cavities, the plurality of sounding cavities of the set are substantially aligned axially with one another,
wherein a number of sets of sounding cavity/cavities associated with each threshold is different from a number of sets of sounding cavity/cavities associated with each other threshold, and
the sets of sounding cavity/cavities associated with each threshold are arranged in such a way that, beyond each threshold, the sets of sounding cavity/cavities associated with that threshold are evenly circumferentially distributed about the tyre.

23. The tyre according to claim 22, wherein each set includes a single sounding cavity.

24. The tyre according to claim 22, wherein each set includes at least two cavities substantially aligned axially with one another.

25. The tyre according to claim 22, wherein, beyond each threshold, each sounding cavity of that threshold opens radially to an exterior of the tyre and is structured in such a way as to be closed by a ground in a substantially airtight manner as that cavity passes through a contact patch in which the tyre is in contact with the ground.

26. The tyre according to claim 22, further comprising:
at least one circumferential groove of a predetermined depth that is predetermined when the tyre is new; and
at least two ribs formed transversely at a bottom portion of the groove, the at least two ribs being of a predetermined height that is predetermined when the tyre is new and that is substantially equal to a difference between the predetermined depth of the groove and one of the predetermined radial wear thresholds,
wherein a distance separating two of the at least two ribs is less than a predetermined distance such that, beyond one or each of the predetermined radial wear thresholds, a cavity formed by the groove and delimited by the two ribs sounds when the tyre is in operation.

27. The tyre according to claim 22, wherein each sounding cavity includes:
a pair of cells respectively arranged in first and second circumferential grooves of the tread, and
a channel joining the pair of cells together.

28. The tyre according to claim 22, wherein the tread is structured in such a way that, beyond each threshold and over a predetermined wear range associated with that threshold, a total volume of the sounding cavity/cavities associated with that threshold is greater than or equal to a non-zero predetermined minimum volume (Vₘᵢₙ).

29. The tyre according to claim 28, wherein two predetermined wear ranges associated with two consecutive thresholds have at least one wear value in common.

30. The tyre according to claim 28, wherein a range Pᵢ associated with each threshold Sᵢ is defined by Pᵢ=[Sᵢ; H−Vₘᵢₙ/(Nᵢ.S)], in which H is a depth distance between a bottom portion of a sounding cavity and a surface of the tyre in a new condition, Vₘᵢₙ is the non-zero predetermined minimum volume, Nᵢ is a number of sounding cavity/cavities associated with that threshold, and S is a contact cross section of each sounding cavity associated with that threshold as the sounding cavity passes through a contact patch in which the tyre is in contact with a ground.

31. The tyre according to claim 28, wherein each threshold Sᵢ satisfies a relationship:
Sᵢ₊₁≦H−Vₘᵢₙ/(Nᵢ.S), with i>1, and/or
Sᵢ≦H−Vₘᵢₙ(Nᵢ.S), with i=1,
in which H is a depth distance between a bottom portion of a sounding cavity and a surface of the tyre in a new condition, Vₘᵢₙ is the non-zero predetermined minimum volume, Nᵢ is a number of sounding cavity/cavities associated with that threshold, and S is a contact cross section of each sounding cavity associated with that threshold as the sounding cavity passes through a contact patch in which the tyre is in contact with a ground.

32. The tyre according to claim 26, wherein the tread is structured in such a way that, beyond each threshold and over a predetermined wear range associated with that threshold, a total volume of the sounding cavity/cavities associated with that threshold is greater than or equal to a non-zero predetermined minimum volume (Vₘᵢₙ), and a height hᵢ, which is predetermined when the tyre is new, of each rib delimiting a cavity associated with that threshold satisfies a relationship:
hᵢ₊₁≧Vₘᵢₙ/(Nᵢ.S), with i>1, and/or
hᵢ≧Vₘᵢₙ/(Nᵢ.S) with i=1,
in which Vₘᵢₙ is the non-zero predetermined minimum volume, Nᵢ is a number of sounding cavity/cavities associated with that threshold, and S is a contact cross section of each sounding cavity associated with that threshold Sᵢ as the sounding cavity passes through a contact patch in which the tyre is in contact with a ground.

33. The tyre according to claim 28, wherein the non-zero predetermined minimum volume (Vₘᵢₙ) is substantially equal to 2 cm³.

34. The tyre according to claim 28, wherein the non-zero predetermined minimum volume (Vₘᵢₙ) is substantially equal to 4 cm³.

35. The tyre according to claim 22, wherein numbers NEᵢ, NEᵢ₊₁ of sets of sounding cavity/cavities associated respectively with two consecutive thresholds Sᵢ, Sᵢ₊₁ satisfy NEᵢ<NEᵢ₊₁, with the threshold Sᵢ₊₁ being higher than the threshold Sᵢ.

36. The tyre according to claim 35, wherein kᵢ=NEᵢ₊₁/NEᵢ>1 for any value of iε[1, M], where M is a total number of predetermined radial wear thresholds, and kᵢ is a natural integer.

37. The tyre according to claim 22, wherein each cavity associated with a given threshold is also associated with a threshold above the given threshold.

38. The tyre according to claim 22, wherein numbers NEᵢ, NEᵢ₊₁ of sets of sounding cavity/cavities associated respectively with two consecutive thresholds Sᵢ, Sᵢ₊₁ satisfy NEᵢ>NEᵢ₊₁, with the threshold Sᵢ₊₁ being higher than the threshold Sᵢ.

39. The tyre according to claim 38, wherein kᵢ=NEᵢ/NEᵢ₊₁>1 for any value of i [1, M], where M is a total number of predetermined radial wear thresholds, and kᵢ is a natural integer.

40. The tyre according to claim 22, wherein the tread is structured in such a way that a sounding cavity has, as the sounding cavity passes through a contact patch in which the tyre is in contact with a ground, a contact cross section that varies as a function of a wear of the tyre.

41. The tyre according to claim 40, wherein the contact cross section increases with the wear of the tyre.

42. The tyre according to claim 22, wherein the tread is structured in such a way that a sounding cavity has, as the sounding cavity passes through a contact patch in which the tyre is in contact with a ground, a contact cross section that is constant as a function of a wear of the tyre.

43. The tyre according to claim 22, wherein the tread is structured in such a way that, beyond each radial wear threshold, all sounding cavities of the tyre are identical.
